(19) United States
(12) Patent Application Publication
(10) Pub. No.: US 2019/0014744 A1
(43) Pub. Date: Jan. 17, 2019

(54) PET CANOPY SYSTEM AND METHOD OF USE

(71) Applicant: Vaheed Fowlkes, Spring, TX (US)

(72) Inventor: Vaheed Fowlkes, Spring, TX (US)

(21) Appl. No.: 16/131,711

(22) Filed: Sep. 14, 2018

Related U.S. Application Data
(63) Continuation-in-part of application No. 15/834,629, filed on Dec. 7, 2017.
(60) Provisional application No. 62/431,121, filed on Dec. 7, 2016.

(51) Int. Cl. A01K 13/00; A01K 27/00; A45B 11/02

(52) U.S. Cl. CPC A01K 13/006; A45B 11/02; A01K 27/002

(57) ABSTRACT

A pet canopy includes a head canopy, having a head frame supporting side shields extending therefrom to protect a pet's head from rain; a body canopy, having a body frame supporting body shields extending therefrom and to protect the pet's body from rain; one or more legs extending from the body frame and having wheels there attached and to rest on a ground surface; and a harness extending from the body frame and to secure to the pet's body.

### BACKGROUND

### 1. Field of the Invention

The present invention relates generally to umbrellas, and more specifically, to a pet umbrella.

### 2. Description of Related Art

Umbrellas are well known in the art and are effective means to divert water away from the user. FIG. 1 illustrates a conventional pet umbrella 101 for use with an animal 105. Umbrella 101 includes a canopy 103 configured to cover the body of animal 105 and is retained in position above the animal via a cane 107, which in turn is loosely secured to the collar 109 of animal 105.

One of the problems commonly associated with umbrella 101 is the limited use. For example, the user is required to stay at a close distance to the animal to keep the canopy above the animal's body. This restriction does not allow the animal to freely walk and/or run without the user nearby. Further, the canopy has to be carried by the cane for the system to be effective.

Although great strides have been made in the area of pet umbrellas, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a side view of a conventional pet umbrella;

FIG. 2 is a side view of a pet umbrella system in accordance with a preferred embodiment of the present application;

FIG. 3 is a top view of the system of FIG. 2 without the canopy;

FIG. 4 is a side view of a pet umbrella system in accordance with an alternative embodiment of the present application;

FIG. 5 is a top view of the system of FIG. 4 without the canopy;

FIG. 6 is a side view of a pet canopy system in accordance with an alternative embodiment of the present application;

FIG. 7 is an oblique view of the pet canopy system of FIG. 6; and

FIG. 8 is an oblique view of the pet canopy of FIG. 6 with the side panels and wheels folded for storage.

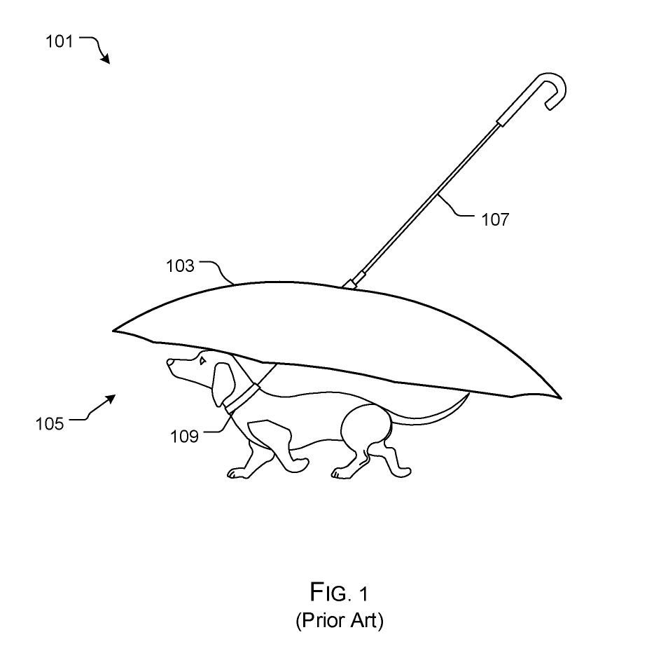

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional pet umbrellas. Specifically, the system of the present application includes effective and rapid means to allow the pet to carry the umbrella canopy while walking and/or running a distance from the pet owner. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

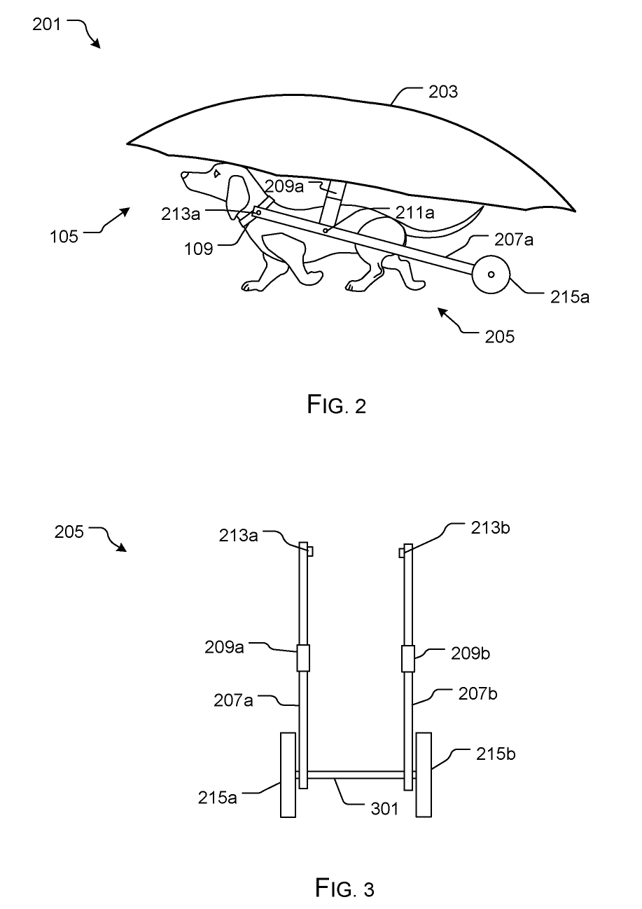

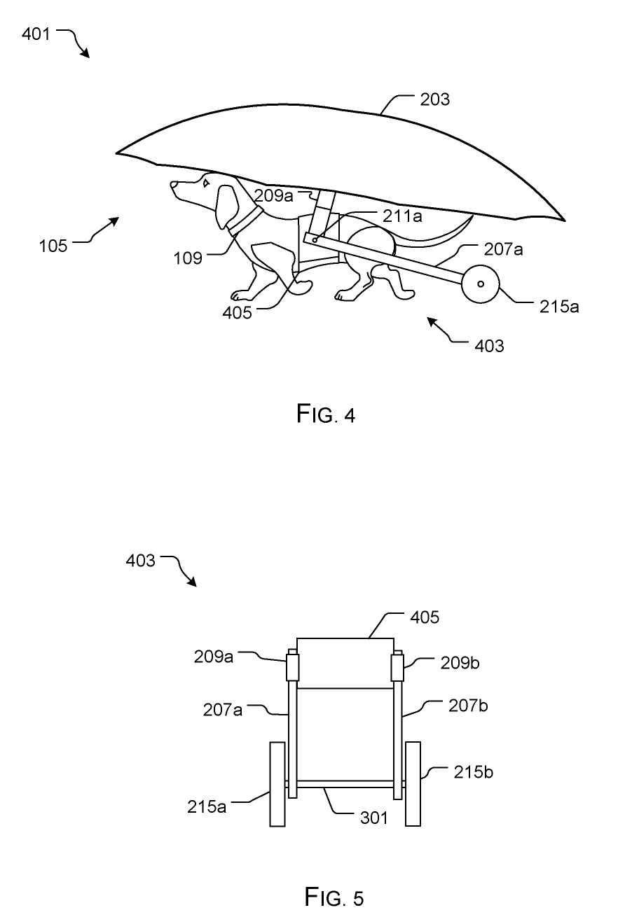

Referring now to the drawings wherein like reference characters identify corresponding or similar elements throughout the several views, FIGS. 2 and 3 depicts respective side and top views of a pet umbrella system 201 in accordance with a preferred embodiment of the present application. It will be appreciated that system 201 overcomes at least one of the above-listed problems commonly associated with the conventional pet umbrellas.

In the contemplated embodiment, system 201 includes a collapsible canopy 203 adjustably secured to a frame 205. During use, the canopy 203 shields the animal from the elements, e.g., wind, dust, sun, rain and so forth.

One of the unique features believed characteristic of the present invention is the ability to secure frame 205 to the animal without the need for the pet owner to be nearby. To achieve this feature, frame 205 includes two horizontal bars 207a, 207b configured to secure to the collar 109 via removable attachment devices 213a, 213b at a first end of bars 207a, 207b and two wheels 215a, 215b rotatably attached to bars 207a, 207b at a second end of bars 207a, 207b. Accordingly, during use the system is adapted to utilize wheels 215a, 215b to assist in the weight of the canopy and to provide structural rigidity. As shown in FIG. 3, the wheels are secured to the bars in addition to a common shaft.

Two adjustable vertical members 209a, 209b are adjustably secured to bars 207a, 207b. In the contemplated embodiment, the members 209a, 209b allow selective adjustment of the canopy away from the bars 207a, 207b along with the ability to pivot the canopy relative to bars 207a, 207b. This feature allows the system to be utilized with animals of different shapes and sizes. In addition, the bars 207a, 207b pivotally attach to collar 109 via pivot joints 213a, 213b, which in turn are also quick release devices to the collar 109.

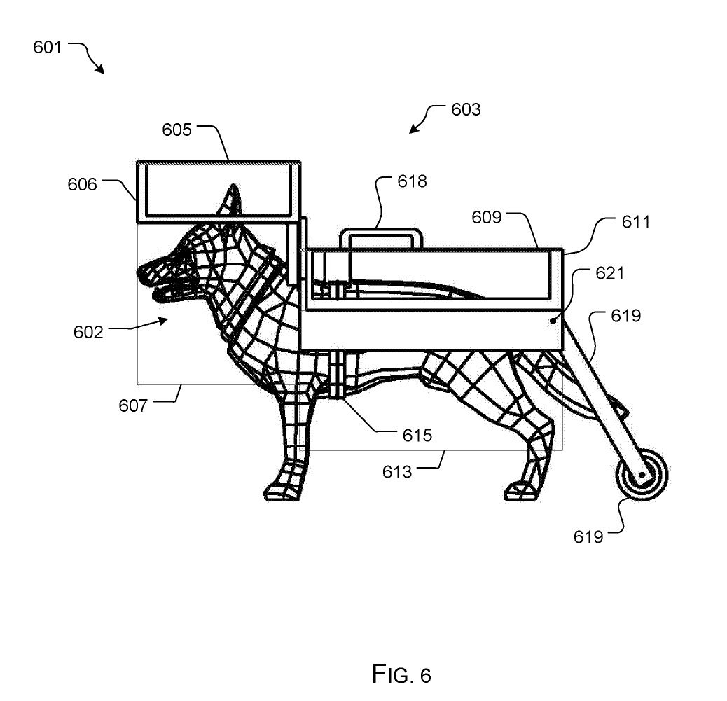

Referring now to FIGS. 4 and 5, respective side and front views of a system 401 are shown. It will be appreciated that system 401 is substantially similar in form and function to system 201 and incorporates the same; however, it is contemplated utilizing a harness 405 with frame 403. The harness 405 eliminates the need to utilize joints 213a, 213b with collar 109. Accordingly, the weight distribution of system 401 is positioned on the body of animal 105 via harness 405 and via wheels 215a, 215b. In the exemplary embodiment, the harness 405 is configured to wrap around the periphery of the animal's body; however, it is also contemplated having a harness the sits on body in an alternative embodiment.

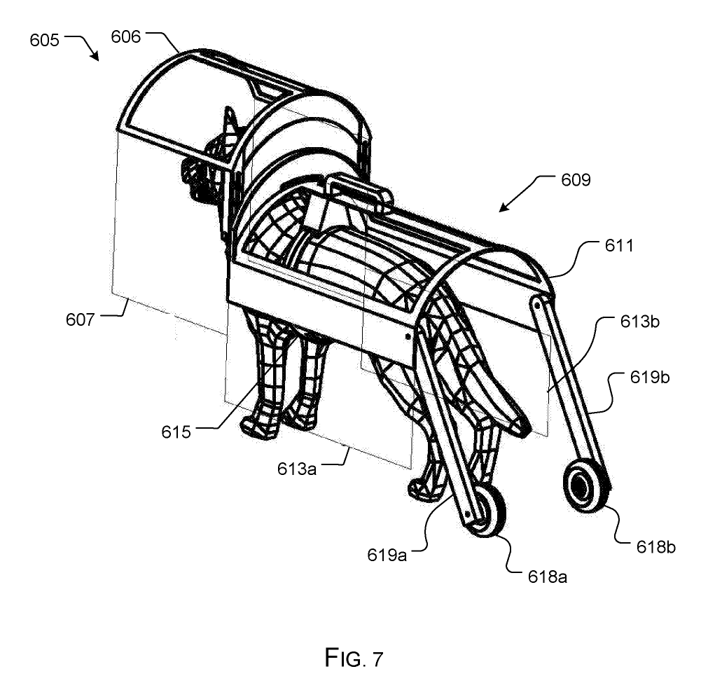

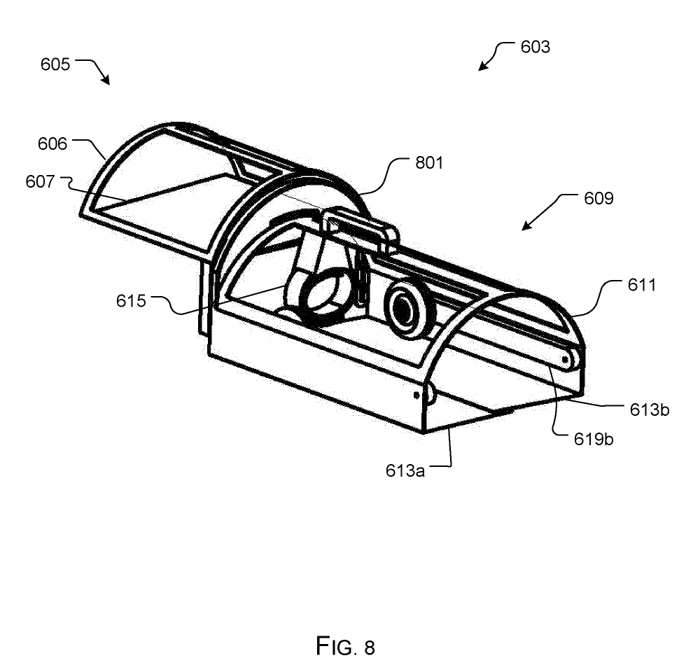

In FIGS. 6-8 an alternative embodiment of a system 601 in accordance with the present application in shown. System 601 includes a canopy 603 secured to a dog 602, wherein the canopy 603 includes a head canopy 605 with a frame 606 supporting side shields 607 extending from the frame and to protect the pet's head and neck regions from rain. Canopy 603 further includes a body canopy 609 with a frame 611 supporting body side shields 613 extending from the frame 611 to protect the pet's body from rain.

The shields 607, 613 are ideally composed of a clear material, such as clear vinyl, thereby allowing for the dog to keep full visibility.

As further shown, the system includes a harness 615 configured to secure the canopy to the pet. It is contemplated that the harness 615 can secure around the mid-section/chest of the pet and can be adjustable as needed. Further, system 601 can include a handle 617 to provide a means for the user to hold and control dog 602.

System 601 further includes one or more wheels 618 attached to legs 619 pivotally attached 621 to frame 611. The legs and wheels aid in supporting canopy 603 above the dog's body.

As shown in FIG. 8, the shields 607, 613 can be hinged, thereby allowing for the shields to fold upwards for storage. Further shown, the legs 619 can pivot into the body canopy for storage. In addition, an extending panel 801 can connect the body canopy to the head canopy, thereby further allowing for the two to collapse towards one another.

It should be appreciated that the system can be modified and adjusted to fit various animals of various sizes.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A pet canopy, comprising:
a head canopy, having:
a head frame supporting side shields extending therefrom and configured to protect a pet's head from rain;
a body canopy, having:
a body frame supporting body shields extending therefrom and configured to protect the pet's body from rain;
one or more legs extending from the body frame and having wheels there attached and configured to rest on a ground surface; and
a harness extending from the body frame and configured to secure to the pet's body.

2. The pet canopy of claim 1, further comprising:
a panel connecting the head frame to the body frame.

3. The pet canopy of claim 2, wherein the panel is collapsible.

4. The pet canopy of claim 1, further comprising:
a handle attached to the body canopy.

5. The pet canopy of claim 1, wherein the side shields include a hinge configured to allow the side shields to fold upwards.

6. The pet canopy of claim 1, wherein the body shields include a hinge configured to allow the body shields to fold upwards.

7. The pet canopy of claim 1, wherein the side shields are composed of vinyl.

8. The pet canopy of claim 1, wherein the one or more legs are pivotally attached to the frame.
